(19) United States
(12) Patent Application Publication
(10) Pub. No.: US 2014/0091566 A1
(43) Pub. Date: Apr. 3, 2014

(54) Method for verifying the authenticity of securities and device for its realization

(71) Applicant: Serghei Vasiliev, Chisinau (MD)

(72) Inventor: Serghei Vasiliev, Chisinau (MD)

(21) Appl. No.: 14/115,652

(22) PCT Filed: May 11, 2012
(86) PCT No.: PCT/MD2012/000003

§ 371 Date: Nov. 7, 2013

(30) Foreign Application Priority Data
May 12, 2011 (MD) A 2011 0043

(51) Int. Cl. B42D 15/00

(52) U.S. Cl. CPC B42D 15/0013
USPC 283/67; 283/85

(57) ABSTRACT

The present invention relates to methods and devices for verifying the authenticity of various securities and may be used for determining the authenticity of banknotes, financial documents, identity cards and other important documents. The method consists in that the security is transilluminated with a light flux passing from a light source to a receiver, is registered the feature of paper, is compared the registration result with the reference feature, obtained during the control test and stored in a database of reference features, the coincidence of signs confirming the authenticity of the security. As a protective element is used an image in the form of a projection on the receiver of patterns, formed by its nearest 1-6 layers of fibers inside the texture of paper, of the preselected control site, the dimensions of which exceed the transverse dimensions of the paper fibers at least twice. It is carried out the identification of security with the ability to locate the control area defined by the coordinates and/or typographical feature, the security is transilluminated with a light flux on the control area, is registered the control area image with a resolution of at least 1200 pixels per inch. In the alternative embodiment of the device for realization of the method for verifying the authenticity of securities, which is a mobile phone, the light source and the receiver being aligned in different parts of the body, the receiver is made in the form of a flat photosensor having a resolution of at least 1200 pixels per inch. In another alternative embodiment the light source is located by the circuit of the photosensor, at the same time the device is equipped with a means for security pressing to the photosensor, reflecting the luminous flux, emitted by the source, on the photosensor. At the same time in both alternative embodiments of the device the protective layer of the photosensor is made in the form of a light-guiding plate with photoconductive elements, which transmit the luminous flux to the surface of the photosensitive layer. The result, achieved at the realization of the present invention, consists in providing the simplicity, high reliability and validity of authentification of securities.

### TECHNICAL FIELD

The present invention relates to methods and devices for verifying the authenticity of various securities and may be used for determining the authenticity of banknotes, financial documents, identity cards and other important documents.

### BACKGROUND ART

Since it is impossible to 100% prevent forgery of securities, including banknotes, the problem for their authentication over time has not lost its relevance and even takes on particular importance, given the rapid development of high technologies which are also used, in particular, for the creation of high-quality fakes.

Currently, there are often situations in which authentication of securities, such as banknotes, identity cards, credit and bank cards, tax stamps, etc., should be carried out directly in the place of physical presence of the subject—the owner of the securities.

There are known the method and device for determining the authenticity of documents described in the U.S. Pat. No. 6,438,362 [1], in which authenticity is determined by detecting the presence of the security element embedded in the document.

The body of the device is made in the form of two coupled with the possibility of relative movement parts, separated by a slot, in which is introduced the document to be verified. In one of the parts are mounted luminous flux radiation means illuminating the verifiable document. In another part symmetrically to the radiation means are mounted luminous flux reception means. These means are a pair of sensors that determine the authenticity of the document and are actuated by a switch.

Sensors are working in infrared light, as radiation means being several infrared light-emitting diodes, and as reception means—several infrared photodiodes.

As protective elements are used threads fitted into specially made on the document boxes, which are control areas. When the document is transilluminated sensors register the presence or absence of protective elements.

Processing of obtained data is carried out by means of a microprocessor transmitting the output signal to the switch.

The disadvantage of the described device is the low reliability of verification results and its limited functionality, determined by the opportunity of verifying only the documents supplied with easy-to-forge protective elements.

[symbol] in technical essence to the claimed method for verify [symbol] of securities is the method for checking banknotes, registered by the Russian patent No 2103740 [2].

The method is based on the measurement of two independent individual spatially-extended attributes of the processed banknote, one of which is determined by the technology of paper production, and another—by the polygraphic banknote printing process. As protective elements in the present invention are the texture of paper and the polygraphic relief of its surface (typographical feature).

This method involves the pre-control testing of verifiable banknotes and other documents, use as a protective element of the feature of the texture of paper and consists in that the security is transilluminated with a luminous flux passing from a light source to a receiver, it is registered the feature of the texture of paper, is compared the result of registration with the reference feature received during the control test and stored in a database of reference features, the coincidence of features serving as confirmation of authenticity of the security.

In the process of realization of this method the surface of the document is irradiated with two scanning optical beams with different wavelengths. With one ray the document is examined, and the past luminous flux is transformed into a first electrical signal to form a first digital code, which is a sign of the texture of paper. The other beam is reflected from the surface of the document, and the reflected luminous flux is transformed into a second digital code that is the typographical feature of the document. Between the first and second digital codes is created a digital combination that is used for comparison with the reference value obtained during the control test of the document.

The comparison of signs of the processed documents, expressed by digital codes, is carried out by a two-stage scheme.

The control testing is carried out during the manufacture of paper, performing the same operations in the same sequence as in the verification of its authenticity.

The realization of this method is carried out using a device containing two laser light sources having different wavelengths and simultaneously irradiating the verifiable document, two scanners, two radiation detectors, two analog-digital converters (ADC), two buffer memory blocks, a synchronizer, a paper texture determination block, a digital combination formation block, a switch, a comparator, and a memory block. In the case of determining the unit of comparison of coincidence of the reference value and the value obtained when testing, the verifiable document is classified as genuine.

The disadvantage of the described method is the high complexity of its realization. To carry out all verification procedures is necessary to use a large number of special technical equ [symbol] diation sources, radiation detectors, scanners, ADC, analyzers, synchronizer, etc.

In this case the possible failures in the work of numerous electronic devices that make up the schematic solution of the device reduce the reliability of its work, and consequently the reliability of realization of the conducted method.

The closest in technical essence to the claimed device for realization of the method for verifying the authenticity of securities, represented by two alternative embodiments, is a device described in the international application WO2008/127144 [3].

This device is a mobile phone, which in addition to its primary purpose determines the authenticity of the used banknotes.

The claimed mobile phone is adapted to the projection of security features by the light passing through a banknote and has a body, containing a light source, a receiver, a display for the visualization of transactions, made with the ability to display the comparison results.

In one alternative embodiment of the device the body is made of two parts which can accommodate between them the security checked for authenticity, the light source and receiver being aligned in different parts of the body. At the same time the parts of the body are connected through an articulation.

In another alternative embodiment the parts of the body are separated by a cut slot for the introduction of the verifiable banknote.

As a receiver, in the mobile phone is used a camera with an optical system.

As stated in the description of the invention, the known mobile phone compares with a special block the images of the verifiable banknote security features received by the camera with the images of standard security features of banknotes of various denominations and types contained in the memory block. So, for example, are checked all recommended by the Central Bank areas of the banknote with protective elements on them.

However, since the capabilities of modern high technologies are also used for creating high-quality fakes, the present invention rather is intended to identify poor-quality fakes, than for the final determination of authenticity of banknotes, as for authenticity research under the current to date techniques is required more sophisticated equipment and skilled personnel (http://www.goznak-mpf.ru/index.php?lang=rus&link=isledovaniya-podlinnosti-banknot).

It should be noted that for comparison are used only protective elements pre-printed on the document, which imposes a restrictive framework for object inspection. Enhancement of functionality of the described device will inevitably require more complicated technology to prepare documents that will increase the cost of their production and, consequently, additional overall funding costs.

To a sufficient degree of reliability compare the protective elem [symbol] mobile phone the banknote both during checking and control testing should be placed so that the position of the main optical axis of the lens relative to the test site may be the same, and also use the same camera in all models of phones. Otherwise, there are distortions, which change the geometry of the image, and thus reduce the accuracy of determining compliance of the checked banknote with the standard one. However, the need for precise setting of the document makes the verification procedure inconvenient for the user.

Furthermore, the use in the patented mobile phone of a camera with an optical system for projecting security features significantly increases its cross-sectional dimensions both at the expense of focusing the distance and the thickness of the camera itself, which does not, comply with the modern trends of development of the given art, aimed at the miniaturization of personal mobile communication facilities.

### DISCLOSURE OF THE INVENTION

The task solved by the present invention consists in the development of a simply implemented, highly reliable and highly effective method for verifying the authenticity of various securities, as well as in the creation of an affordable and convenient to use device for its realization, which has a wide range of possible applications and does not require special technology of preparing the verifiable objects.

The undertaken task is solved by the fact that in the method for verifying the authenticity of securities with pre-control test by using as a protective element the feature of the texture of paper, consisting in the fact that the security is transilluminated with a light flux passing from a light source to a receiver, is recorded the feature of the texture of paper, is compared the registration result with the reference feature, obtained during the control test and stored in a database of reference features, the coincidence of features confirming the authenticity of the security, as a protective element is used an image in the form of a projection on the receiver of patterns, formed by its nearest 1-6 layers of fibers inside the texture of paper, of the pre-selected control site, the dimensions of which exceed the transverse dimensions of the paper fibers at least twice, it is carried out the identification of security with the ability to locate the control area defined by the coordinates and/or typographical feature, the security is transilluminated with a light flux on the control area, is registered the control area image with a resolution of at least 1200 pixels per inch.

At the same time the security is identified by reading the identification data from the radio chip fixed on it at the manufacture.

Also, the security is identified by reading the identification data from the superposed thereon multidimensional bar code.

[symbol] er, the databases of reference signs are placed o [symbol] on the Internet.

The comparison of control area image with the reference sign is carried out with software products that provide for the visualization of comparison results.

The undertaken task is also solved due to the fact that in one alternative embodiment of the device for realization of the method, which is a mobile phone, made with the possibility of projecting the protective elements of the security in the light passing through it and having a body composed of two parts with the possibility of placing between them the security to be verified for authenticity and containing a light source, a receiver, a display for the visualization of performed operations, made with the possibility to display the comparison results, the light source and the receiver being aligned in different parts of the body, the receiver is made in the form of a flat photosensor having a resolution of at least 1200 pixels per inch, the protective layer of which is made in the form of a light-guiding plate with photoconductive elements, which transmit the luminous flux to the surface of the photosensitive layer.

The undertaken task is also solved due to the fact that in another alternative embodiment the device for realization of the method, which is a mobile phone, made with the possibility of projecting the protective elements of the security in the light passing through it and having a body composed of two parts with the possibility of placing between them the security to be verified for authenticity and containing a light source, a receiver, a display for the visualization of performed operations, made with the possibility to display the comparison results, the light source and the receiver being aligned in different parts of the body, the receiver is made in the form of a flat photosensor having a resolution of at least 1200 pixels per inch, the protective layer of which is made in the form of a light-guiding plate with photoconductive elements, which transmit the luminous flux to the surface of the photosensitive layer, the light source is located by the circuit of the photosensor, at the same time the device is equipped with a means for security pressing to the photosensor, reflecting the luminous flux, emitted by the source, on the photosensor.

The means for security pressing to the photosensor is designed as a geometric body of arbitrary shape, the compressing surface of which mates with the relevant part of the body.

Moreover, both alternative embodiments of the device are equipped with a radio chip readout unit.

The light source is a single light emitter or a set of single emitters.

At the same time the photoconductive elements are made in the form of segments of optical fibers, placed perpendicular to the working surface of the light-guiding plate.

Also, the photoconductive elements are made in the form of through holes, placed perpendicular to the working surface of the light-guiding plate and filled at least on one side with transparent solid material.

Moreover, the transverse dimension of photoconductive elements and the distance between the longitudinal axes of adjacent photoconductive elements are no more than 0.02 mm, at the same time it is preferred that the photoconductive elements be in alignment with the pixels in the photosensitive layer.

The result, achieved at the realization of the present invention, consists in its simplicity, high reliability and validity of authentication of securities.

As you know, paper, including the one used for the manufacture of banknotes and various documents, has a specific fiber structure defined by the technological features of the method of its production. This structure is randomly generated for each copy of any document and can not be forged.

Upon multiple enlargements one can see that the paper is a three-dimensional structure formed by randomly arranged fibers, the fibers being distributed not only by the plane, but also by the thickness, and voids are filled with a transparent adhesive. By the thickness of a standard sheet of paper depending on its quality are arranged from 10 to 20 layers of fibers.

When viewed in transmitted light the three-dimensional structure of the paper is presented as a chaotic pattern formed by intertwining and intersecting fibers, such as wood, most clearly visible are fibers of the 1-6 closest to the surface from the end of the receiver layers of fibers with all formed by them geometric patterns. The fibers of the deeper layers create a blurred background, which also has its own peculiarities.

At the same time the pattern, created in the transmitted light by the closest to the surface layers of fibers of the paper material, is a unique and independent of the physical state of the verifiable object, for example, the old banknotes, the worn documents, etc.

The presence of the dye on the surface of the paper only enhances the uniqueness of the created pattern and further enhances the reliability of the obtained result.

The use in the proposed method as a protective element of the image of 1-6 layers of paper texture of the verifiable document, closest to the receiver and representing nonreproducing natural information, provides a high degree of reliability of authentication.

The dimensional measurement of the control area, as exceeding the transverse dimensions of paper fibers at least twice, is necessary to obtain a pattern that is sufficient for the required level of its complexity, as a protective element.

On the given by such dimensions controlled area in any case there is a specific random unique pattern of overlays and intertwining of fibers that are unique only to the given area.

Registration of the control area image with a resolution of at least 1200 pixels per inch provides a firm view of the material structure, since the pixel size for this value is 0.02 mm, which corresponds to the upper value of the thickness of the paper fiber.

In order to forge the master protective element, with which the comparison is made in the verification process, there must be repeated exactly the location and shape of fibers in the texture of the material, which is impossible even with the known high technology.

However, passing through layers of paper, light is scattered in a natural way and at the outlet the light rays are directed at different angles to its surface. In the known photosensors the protective layer, representing a glass plate, is at a distance from the photosensitive layer, therefore there is such a scattering of rays that the patch formed on the surface of the photosensitive layer can not properly provide a clear projection of patterns, which are a protective element.

In order to provide a clear picture at the entrance into the photosensitive layer of the photosensor, its protective layer is made as a light-guiding plate with photoconductive elements, which transmit the luminous flux directly to the surface of the photosensitive layer.

Taking into account that according to the invention the control area image registration is carried out with a resolution of at least 1200 pixels per inch, the cross-sectional dimension of the photoconductive element, as well as the distance between the longitudinal axes of adjacent elements should be less than 0.02 mm.

When using photosensors with greater resolution these dimensions may be reduced accordingly.

Execution of the photoconductive elements of the reflector plate in the form of segments of optical fibers or through holes, filled from the end of the controlled paper with transparent solid material not only provides the guaranteed delivery of the directed luminous flux to the photosensitive layer, but also protects it from environmental conditions (humidity, dust and mechanical influences).

The use of a flat photosensor as a receiver in both alternative embodiments of the mobile phone facilitates both the miniaturization and reduction in the cost of the proposed device for realization of the method.

Placement in the second alternative embodiment of the device of the light source by the circuit of the photosensor and the use of the means for security pressing to the photosensor, possessing the property of reflecting the luminous flux emitted by the source on the photosensor, allows, as in the first embodiment, to verify the authenticity of the security in the transmitted light using all the advantages of this method of verification, but at the same time additionally simplifies and reduces the cost of construction of the device.

Indeed, the photosensor with the light source located by the circuit can be mounted on any surface (front, back, side) of any of the finest personal mobile communication facility, which eliminates the need to use only mobile phones with a lid or create artificial slots in the case.

The ease of realization of the method is determined by the high level of development of information technologies, due to which access to databases, including databases formed to store the reference features of a wide range of verification objects, is unlimited. Typically, such data are available on specialized sites on the Internet, the information about which is available to any user. Thus, with the present level of development of communication facilities, including mobile, communication networks, software tools, the realization of the proposed method and device requires virtually no additional cost.

Also, keep in mind, and it is used in the claimed invention, that modern technologies use in an increasing scale the identification of objects by reading the data from the radio chips fixed thereon and superposed dimensional bar codes, which also simplifies the security authentication process.

The proposed alternative embodiments of the device for realization of the method, equipped with modern elemental means and using the necessary software products, perform all operations of the method quickly and accurately.

Thus, the claimed invention with the whole simplicity of its realization provides a higher degree of certainty of authentication of the securities. At the same time both alternative embodiments of the device are reliable and easy to use, does not require in the process of manufacture substantial additional material, labor and financial costs, and also have almost unlimited functionality.

Summary of the invention is explained by the following description and drawings.

The method is realized as follows.

The authorized organization conducts the pre-control testing of the security in order to obtain images of the protective element—the reference feature for subsequent comparison. At the same time as the protective element is used an image in the form of a projection on the receiver of patterns, formed by its nearest 1-6 layers of fibers inside the texture of paper, of the pre-selected control area, the dimensions of which exceed the transverse dimensions of the paper fibers at least twice. It is carried out the registration of the reference feature of the texture of paper on the control area and it is stored in a database of reference features, placed on the appropriate specialized site on the Internet.

When authenticating a security it is carried out its identification with the possibility of determining the position of the control area, given by the coordinates and/or typographical feature. To this end, the security, equipped with a radio chip fixed thereon at the manufacture, is [symbol] eading from the radio chip the identification data [symbol] essary information.

If the security is provided with a multidimensional bar code, the necessary information is read from the bar code, at the same time it is preferred the placement of the control area at the location of the multidimensional bar code.

Further, the security on the control area is transilluminated with a luminous flux passing from a light source to a receiver, and it is recorded the control area image with a resolution of at least 1200 pixels per inch. The result of registration is compared with the reference feature, obtained during the control test and stored in a database of reference features, and the coincidence of features confirms the authenticity of the security.

The person interested in verifying the authenticity of a security, for a preliminary review of the verification process, can take advantage of the instructions posted on dedicated sites on the Internet and/or on paper carriers.

In the process of realization of the method are, used traditional for mobile phones and personal computers, widely described in literature and well known to those skilled in the art methods, hardware and software.

In connection with the use of traditional methods and means within the framework of the present invention, they will not be described in detail.

As an authorized organization can act, proceeding from the purpose of verification, the producers of securities and/or any other institutions that manage specialized databases, such as credit and banking institutions, institutions of MIA, various security institutions and others.

### BRIEF DESCRIPTION OF DRAWINGS

FIG. 1 schematically depicts the front view of the first alternative embodiment of the device for realization of the method for verifying the authenticity of securities, representing a mobile phone;

FIG. 2 shows the cross section of A-A device in FIG. 1;

FIG. 3 schematically shows the front view of the second alternative embodiment of the device for realization of the method for verifying the authenticity of securities, representing a mobile phone;

FIG. 4 shows the cross-section of B-B device in FIG. 3;

FIG. 5 shows the cross-section of the photosensor.

The mobile phone, shown in FIGS. 1 and 3, comprises a case 1, on the front side of which are placed a display 2 and a keyboard 3.

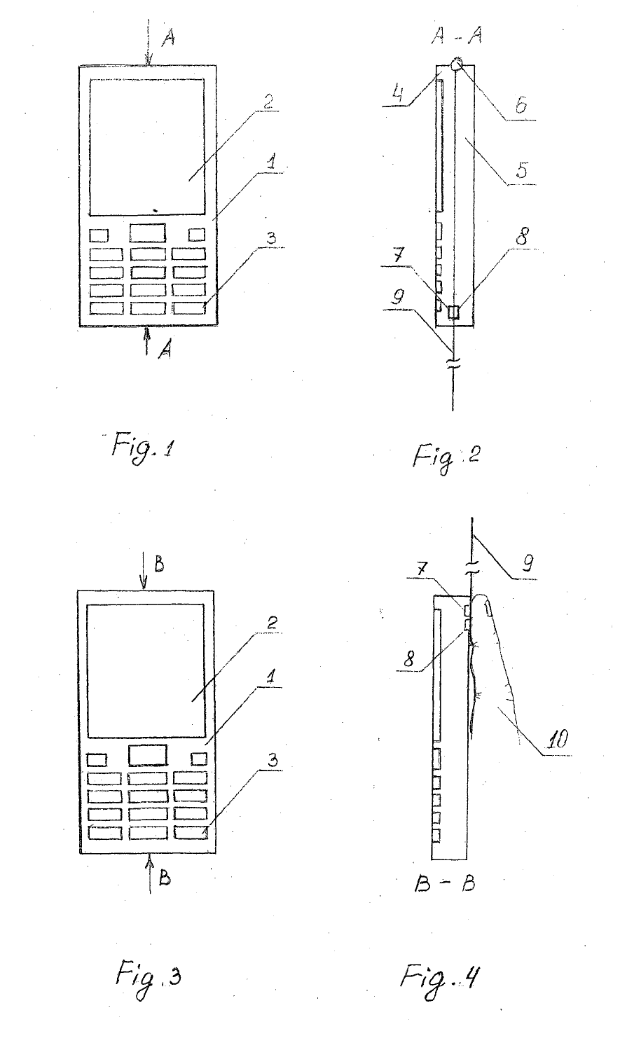

The cross-section of A-A (FIG. 2) of the first alternative embodiment of the device illustrates a construction, consisting of two parts: the front part 4 and the rear part 5, connected by a joint 6. On the outer side of part 4 of the case 1 are placed a display 2 and a keyboard 4 and on its inner side is mounted a light source 7. At the same time on the inner side of part 5 is fixed coaxially to the source 7 a photosensor 8.

In this alternative embodiment of the device the verifiable paper 9 is placed between the parts 4 and 5 of the case 1.

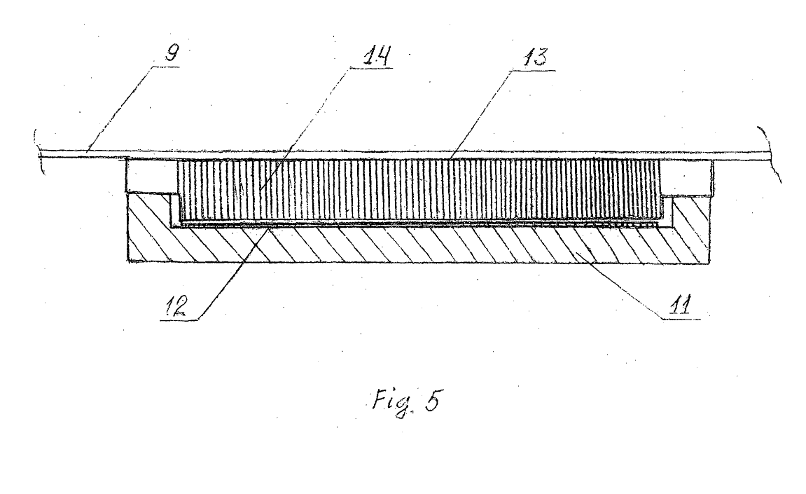

In the second alternative embodiment of the device (FIG. 3) its case is a one-piece construction, on the front side of which are placed a display 2 and a keyboard 3. On the cross-section of B-B (FIG. 4) is shown that on the rear side of the case is placed a photosensor 8, and by its circuit is placed a light source 7.

According to the second alternative embodiment of the device it provides a means for security pressing 9 to the photosensor 8, made in the form of a geometric body of arbitrary shape. In particular, as such affordable and convenient means is used a finger 10 (FIG. 4), the rear side of which satisfies all the necessary properties of the pressing device.

The represented in FIG. 5 cross-section of photosensor 8 shows its structure containing the case 11, in which are located one above the other a photosensitive layer 12 and a light-guiding plate 13 having photoconductive elements 14. On the plate 13 is placed the verifiable security 9.

In the process of realization of the claimed method for verifying the authenticity of securities by using the proposed embodiments of the device the owner of the mobile phone carries out the identification of the security with the possibility of determining the location of the control area.

To do this, when testing securities, equipped with a multidimensional bar code, the security 9 is placed with its face to the photosensor 8 so that when light passes from the source 7 on the display screen 2 may fully be visible the projection of the bar code. Then it is pressed the random key on the keyboard 3 which initiates a program that performs the storage of the image.

At the same time in the first alternative embodiment of the device the security 9 is placed inside the body 1 between the parts 4 and 5, while in the second alternative embodiment it is placed on the rear side of the case 1, pressing it to the photosensor 8 with the possibility of passing the light, reflected by the pressing means, through the security to the photosensor.

In both alternative embodiments of the device the luminous flux, passing through the control area of the verifiable security 9, falls on the surface of the light-guiding plate 13 and through photoconductive elements 14 penetrates through it almost perpendicular to the surface of the photosensitive layer 12.

At the same time the photosensitive layer 12 registers the image of the projection of patterns formed by its nearest 1-6 layers of fibers inside the texture of paper, which is a protective element.

Further, the mobile phone using a special program decrypts the information stored in a multidimensional bar code, and wirelessly sends a request in the form of image of the projection of said bar code with the decrypted coordinates of the reference feature on the site listed in the bar code and containing the relevant data base of reference features.

Upon entry of the request the site server automatically queries the database according to the received coordinates the image of the reference feature created during the control test.

In accordance with the preset program the server compares the protective element of the verifiable security located on the control area with the reference sign, and sends the comparison result to the display 2 of the mobile phone, where it is reproduced as a picture with marked differences and/or as a percentage estimation of coincidence of the paper texture features.

To check the authenticity of securities, equipped with a radio chip fixed thereon, the mobile phone is equipped with a radio chip readout unit. When bringing the radio chip nearer to the phone and pressing the corresponding key the specified unit reads the information and on the display appears the security sample image with the indication of location of the control area. The security is further placed with its face to the photosensor 8 so that on the display 2 may completely be visible the projection image of said control area.

The further process for verification of authenticity of such security is similar to the process described in the case of multidimensional bar code marking.

Given the current level of development of hardware and software, mobile communication, high speed of information processing and transmission via communication channels, when using the present invention one can speak about the speed and reliability of authentication of securities that can not he achieved using solutions known in the state of the art.

Further, the summary of the invention is illustrated by some examples of its realization. It should be noted, however, that these examples do not limit the scope of claims of the applicant, and are only an illustration of the benefits of this solution compared to the existing state of the art.

### EXEMPLARY EMBODIMENTS OF INVENTION

### Embodiment 1

In the process of development of this invention was created an experimental model of mobile phone, corresponding to the first embodiment of the device for verifying the authenticity of securities.

As a basic mobile phone was used a phone of the Apple Company, model Iphone 4G (http://www.apple.com/ru/iphone/features.html). In the case instead of the camera placed on the back surface was built-in a photosensor, model OV5650, production of the OmniVision Company (http://www.ovt.com/products/category.Php? Id=11), which provides a resolution of up to 14400 pixels per inch.

A protective layer of the photosensor was used a plate, cut from [symbol] close-packed optical fibers of a diameter of 1 mm, impregnated with adhesive of grade FG-500CC. The size of the plate corresponded to the area of the photosensitive layer and its thickness was equal to 2 mm.

With the help of a hinge the specially designed lid with a built-in light source of the model LXCL-PWF4 of the Future Lighting Solutions Company (http://www.futurelightingsolutions.com/en/echnologies/Semiconductors/Lighting-Solutions/High-Power-LED-Emitters/White/Pages/7541667-LXCL-PWF4.aspx? ManufacturerName=PHILIPS-LUMILEDS & isFLS=true) was attached to the back surface of the phone so that the light source was positioned coaxially with the photosensor.

For the experiment has been previously selected a set of bottles of vintage wine, for which a database of reference features was created on the Internet website, representing an image of the area projection of 1 mm×1 mm in size, strictly located in the center of the AZTEC-codes of 2.5 mm×2.5 mm in size superposed on the excise stamps with a laser printer.

For authenticity was verified the excise stamp fixed on the bottle of vintage wine from the given set.

In the verification process was chosen any bottle, the free end of the excise stamps of which was clamped in the slot between the phone parts, namely between the photosensor and light source, so that on the display was fully visible the projection of the AZTEC-code printed on it. It was pressed the keyboard key, launching a specially created program, by which all subsequent operations were performed automatically:
mobile phone memorized the AZTEC-code image;
mobile phone using the “Neo Reader” program (http://www.neoreader.com/nokia.html?&no_cache=1) decrypted the AZTEC-code image;
the AZTEC-code projection image along with the decrypted coordinates (the serial number of the excise stamp) of the reference feature (security element) was sent to the site specified in the AZTEC-code;
the server site acquired in the database the reference feature image according to the received coordinates and
using the “Image comparer” program (http://www.image-comparer.com-about.com/) compared the tested and reference features of the texture of paper;
the comparison result was sent to the mobile phone and displayed on its screen.

As a result of carried out operations on the display was shown the percentage of coincidence of the protective and reference features, equal to 95%.

This obtained result confirms the original origin of the selected product.

Time of the carried out verification was 7 seconds.

### Embodiment 2

In the process of development of this invention was created an experimental model of mobile phone, corresponding to the second embodiment of the device for verifying the authenticity of securities.

As in the embodiment 1, as a basic mobile phone was used a phone of the Apple Company, model Iphone 4G and in the case instead of the camera placed on the back surface was built-in a photosensor, model OV5650, production of the OmniVision Company (http://www.ovt.com/products/category.Php? Id=11), which provides a resolution of up, to 14400 pixels per inch.

Similarly, as protective layer of the photosensor was used a plate, cut from the beam of close-packed optical fibers of a diameter of 1 mm, impregnated with adhesive of grade FG-500CC. The size of the plate corresponded to the area of the photosensitive layer and its thickness was equal to 2 mm.

Close by the photosensor was installed a built-in,light source of the model LXCL-PWF4 of the Future Lighting Solutions Company.

For the experiment was used a batch of ten-rouble notes, for which a database of reference features was created on the Internet website, representing an image of the area projection of 1 mm×1 mm in size, strictly located in the center of the AZTEC-codes of 2.5 mm×2.5 mm in size superposed on the excise stamps with a laser printer.

In the verification process was chosen any note, which was pressed with the finger to the photosensor of the phone, so that on the display was fully visible the projection of the AZTEC-code printed on it. It was pressed the keyboard key, launching a specially created program, by which all subsequent operations were performed automatically:
mobile phone memorized the AZTEC-code image;
mobile phone using the “Neo Reader” program decrypted the AZTEC-code image;
the AZTEC-code projection image along with the decrypted coordinates (the serial number of the excise stamp) of the reference feature (security element) was sent to the site specified in the AZTEC-code;
the server site acquired in the database the reference feature image according to the received coordinates and
using the “Image comparer” program compared the tested and reference features of the texture of paper;
the comparison result was sent to the mobile phone and displayed on its screen.

As a result of carried out operations on the display was shown the percentage of coincidence of the protective and reference features, equal to 95%.

This obtained result confirms the genuineness of the selected note.

Time of the carried out verification was 7 seconds.

1-13. (canceled)

14. A method for verifying the authenticity of securities with pre-control test by using as a protective element the feature of the texture of paper, consisting in the fact that the security is transilluminated with a light flux passing from a light source to a receiver, is registered the feature of the texture of paper, is compared the registration result with the reference feature, obtained during the control test and stored in a database of reference features, the coincidence of signs confirming the authenticity of the security, characterized in that as a protective element is used an image in the form of a projection on the receiver of patterns, formed by its nearest 1-6 layers of fibers inside the texture of paper, of the pre-selected control site, the dimensions of which exceed the transverse dimensions of the paper fibers at least twice, it is carried out the identification of security with the ability to locate the control area defined by the coordinates and/or typographical feature, the security is examined with a light flux on the control area, is recorded the control area image with a resolution of at least 1200 pixels per inch.

15. The method as set forth in claim 14, wherein the security is identified by reading the identification data from the radio chip fixed on it at the manufacture.

16. The method as set forth in claim 14, wherein the security is identified by reading the identification data from the superposed thereon multidimensional bar code.

17. The method as set forth in claim 14, wherein the databases of reference features are placed on specialized sites on the Internet.

18. The method as set forth in claims 14, wherein the comparison of control area image with the reference sign is carried out with software products that provide for the visualization of comparison results.

19. A device for realization of the method for verifying the authenticity of securities, which is a mobile phone, made with the possibility of projecting the protective elements of the security in the light passing through it and having a body composed of two parts with the possibility of placing between them the security to be verified for authenticity and containing a light source, a receiver, a display for the visualization of performed operations, made with the possibility to display the comparison results, the light source and the receiver being aligned in different parts of the body, characterized in that the receiver is made in the form of a flat photosensor having a resolution of at least 1200 pixels per inch, the protective layer of which is made in the form of a light-guiding plate with photoconductive elements, which transmit the luminous flux to the surface of the photosensitive layer.

20. A device for realization of the method for verifying the authenticity of securities, which is a mobile phone, made with the possibility of projecting the protective elements of the security in the light passing through it and having a body composed of two parts with the possibility of placing between them the security to be verified for authenticity and containing a light source, a receiver, a display for the visualization of performed operations, made with the possibility to display the comparison results, characterized in that the receiver is made in the form of a flat photosensor having a resolution of at least 1200 pixels per inch, the protective layer of which is made in the form of a light-guiding plate with photoconductive elements, which transmit the luminous flux to the surface of the photosensitive layer, the light source is located by the circuit of the photosensor, at the same time the device is equipped with a means for security pressing to the photosensor, reflecting the luminous flux, emitted by the source, on the photosensor.

21. The device as set forth in claim 20, wherein the means for security pressing to the photosensor is designed as a geometric body of arbitrary shape, the compressing surface of which mates with the relevant part of the body.

22. The device as set forth in claim 19, wherein it is equipped with a radio chip readout unit.

23. The device as set forth in claim 19, wherein the light source is a single light emitter or a set of single emitters.

24. The device as set forth in claim 19, wherein the photoconductive elements are made in the form of segments of optical fibers, placed perpendicular to the working surface of the reflector plate.

25. The device as set forth in claim 19, wherein the photoconductive elements are made in the form of through holes, placed perpendicular to the working surface of the light-guiding plate and filled at least on one side with transparent solid material.

26. The device as set forth in claim 19, wherein the transverse dimension of photoconductive elements and the distance between the longitudinal axes of adjacent photoconductive elements are no more than 0.02 mm.

27. The device as set forth in claim 20, wherein it is equipped with a radio chip readout unit.

28. The device as set forth in claim 20, wherein the light source is a single light emitter or a set of single emitters.

29. The device as set forth in claim 20, wherein the photoconductive elements are made in the form of segments of optical fibers, placed perpendicular to the working surface of the reflector plate.

30. The device as set forth in claim 20, wherein the photoconductive elements are made in the form of through holes, placed perpendicular to the working surface of the light-guiding plate and filled at least on one side with transparent solid material.

31. The device as set forth in claim 20, wherein the transverse dimension of photoconductive elements and the distance between the longitudinal axes of adjacent photoconductive elements are no more than 0.02 mm.
